(19) United States
(12) Patent Application Publication
(10) Pub. No.: US 2008/0298213 A1
(43) Pub. Date: Dec. 4, 2008

(54) OPTICAL DISC APPARATUS AND OPTICAL DISC RECORDING AND REPRODUCTION METHOD

(75) Inventor: Hirokazu SHOU, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/128,830

(22) Filed: May 29, 2008

(30) Foreign Application Priority Data
May 31, 2007 (JP) 2007-146023

(51) Int. Cl. G11B 7/00

(52) U.S. Cl. 369/112.23

(57) ABSTRACT

In an optical disc apparatus, a CPU controls a focus control circuit, and a focus offset for adjusting a height of an objective lens is set. A spindle motor control circuit, a laser driver circuit, and an RF amplifier are controlled. When an optical disc is rotated by using the set focus offset in a state where a tracking servo is not performed, an envelope of a full addition signal or a RF signal obtained from each focused focal point corresponding to the objective lens in a land and a groove is detected. An amplitude level of the envelope is measured, and a focus control circuit is controlled. By using the focus offset with which the amplitude level of the envelope of the full addition signal or the RF signal is minimized, a focus offset used when recording or reproduction of the optical disc is performed is determined.

### CROSS REFERENCE TO RELATED APPLICATIONS

This application claims the benefit of priority of Japanese Patent Application No. 2007-146023, filed in Japan on May 31, 2007, the entire contents of which are incorporated herein by reference.

### BACKGROUND OF THE INVENTION

1. Field of the Invention

The present invention relates to an optical disc apparatus and an optical disc recording and reproduction method. In particular, the invention relates to an optical disc apparatus and an optical disc recording and reproduction method in which it is possible to adjust a focus offset applied to a focus error signal.

2. Description of the Related Art

Up to now, in order to improve an accuracy in focal point positioning of a beam spot irradiated on an optical disc, an adjustment is performed on a focus offset applied to a focus error signal. For example, in this focus offset adjustment, a focus offset is adjusted so that the maximum tracking error signal amplification can be obtained, or, thereafter, a minute adjustment is further performed so that a read rate of a header is maximized (for example, refer to Japanese Unexamined Patent Application Publication Nos. 2000-155961 and 2002-319155).

According to the technology proposed in Japanese Unexamined Patent Application Publication No. 2000-155961, the focus offset can be adjusted so that reproduction states in a land and a groove (jitter and bit error rate) become satisfactory. In addition, according to the technology proposed in Japanese Unexamined Patent Application Publication No. 2002-319155, the focus offset can be adjusted in such a manner that the focus offset is first adjusted on the basis of reproduction error information and thereafter the focus offset is adjusted so that a fluctuation amount of the focus error signal in a land and groove switching part becomes small.

In a case of employing only the adjustment method of adjusting the focus offset so that the maximum tracking error signal amplification can be obtained, if a signal at the header section leaks into the tracking error signal, the signal at the header section may be erroneously sampled in some cases. Therefore, it is difficult to perform the focus offset adjustment with a high accuracy. In view of the above, in the past, after this adjustment, the minute adjustment is further performed so that the read rate of the header is maximized. However, in this case, in the stage of the former adjustment, it is necessary to establish a condition that any header read rate can be measured with certainty.

Also, according to the technologies proposed in Japanese Unexamined Patent Application Publication Nos. 2000-155961 and 2002-319155 as well, in order to correctly evaluate the reproduction states, it is necessary to establish at least such conditions that “an RF signal exists (a state in which recording has been carried out)” and “a header at a sector of evaluating the reproduction states can satisfactorily perform the reproduction”. Therefore, in the case of using this technology, when an unrecorded disc is used, it is necessary to perform recording once in order to meet these conditions.

In this manner, according to the related art technologies, it is necessary to read the header in either case, and in order to read the header, the RF signal needs to be binarized as a premise. Thus, it is necessary to adjust a PLL circuit, etc.

### SUMMARY OF THE INVENTION

Accordingly, the present invention has been made in view of the above-mentioned circumstances, and it is an object of the present invention to provide an optical disc apparatus and an optical disc recording and reproduction method in which without using a header read rate, it is possible to simply and also preferably adjust a focus offset.

In order to solve the above-mentioned problem, according to an aspect of the present invention, there is provided an optical disc apparatus, including: a setting unit configured to set an adjustment focus offset for adjusting a height of an objective lens provided to an optical pickup; a detection unit configured to detect an envelope of a full addition signal or an RF signal obtained from each focused focal point corresponding to a position of the objective lens in a land and a groove formed on the optical disc when the optical disc is rotated in a state where a tracking servo is not performed by using the focus offset which is set by the setting unit; a measurement unit configured to measure an amplitude level of the envelope of the full addition signal or the RF signal detected by the detection unit; and a determination unit configured to determine a record reproduction focus offset used when recording or reproduction of the optical disc is carried out, on the basis of the adjustment focus offset with which the amplitude level of the envelope of the full addition signal or the RF signal measured by the measurement unit is minimized.

In order to solve the above-mentioned problem, according to another aspect of the present invention, there is provided an optical disc apparatus, including: a setting unit configured to set an adjustment focus offset for adjusting a height of an objective lens provided to an optical pickup; a detection unit configured to detect an envelope of a full addition signal or an RF signal obtained from each focused focal point corresponding to a position of the objective lens in a land and a groove formed on the optical disc when the optical disc is rotated in a state where a tracking servo is performed by using the focus offset which is set by the setting unit; a measurement unit configured to measure an amplitude level of the envelope of the full addition signal or the RF signal detected by the detection unit; and a determination unit configured to determine a record reproduction focus offset used when recording or reproduction of the optical disc is carried out, on the basis of the adjustment focus offset with which the amplitude level of the envelope of the full addition signal or the RF signal measured by the measurement unit is minimized.

In order to solve the above-mentioned problem, according to another aspect of the present invention, there is provided an optical disc recording and reproduction method, including: a setting step of setting an adjustment focus offset for adjusting a height of an objective lens provided to an optical pickup; a detection step of detecting an envelope of a full addition signal or an RF signal obtained from each focused focal point corresponding to a position of the objective lens in a land and a groove formed on the optical disc when the optical disc is rotated in a state where a tracking servo is not performed by using the adjustment focus offset which is set through a processing in the setting step; a measurement step of measuring an amplitude level of the envelope of the full addition signal or the RF signal detected through a processing in the detection step; and a determination step of determining a record reproduction focus offset used when recording or reproduction of the optical disc is carried out, on the basis of the adjustment focus offset with which the amplitude level of the envelope of the full addition signal or the RF signal measured through a processing in the measurement step is minimized.

In order to solve the above-mentioned problem, according to another aspect of the present invention, there is provided an optical disc recording and reproduction method, including: a setting step of setting an adjustment focus offset for adjusting a height of an objective lens provided to an optical pickup; a detection step of detecting an envelope of a full addition signal or an RF signal obtained from each focused focal point corresponding to a position of the objective lens in a land and a groove formed on the optical disc when the optical disc is rotated in a state where a tracking servo is performed by using the adjustment focus offset which is set through a processing in the setting step; a measurement step of measuring an amplitude level of the envelope of the full addition signal or the RF signal detected through a processing in the detection step; and a determination step of determining a record reproduction focus offset used when recording or reproduction of the optical disc is carried out, on the basis of the adjustment focus offset with which the amplitude level of the envelope of the full addition signal or the RF signal measured through a processing in the measurement step is minimized.

In the optical disc apparatus according to the aspect of the present invention, the adjustment focus offset for adjusting the height of the objective lens provided to the optical pickup is set, the envelope of the full addition signal or the RF signal obtained from each focused focal point corresponding to the position of the objective lens in the land and the groove formed on the optical disc is detected when the optical disc is rotated in a state where the tracking servo is not performed by using the set adjustment focus offset, the amplitude level of the envelope of the full addition signal or the RF signal which is detected is measured, and the record reproduction focus offset is determined which is used when recording or reproduction of the optical disc is carried out, on the basis of the adjustment focus offset with which the measured amplitude level of the envelope of the full addition signal or the RF signal is minimized.

Also, in the optical disc apparatus according to the aspect of the present invention, the adjustment focus offset for adjusting the height of the objective lens provided to the optical pickup is set, the envelope of the full addition signal or the RF signal obtained from each focused focal point corresponding to the position of the objective lens in the land and the groove formed on the optical disc is detected when the optical disc is rotated in a state where the tracking servo is performed by using the set adjustment focus offset, the amplitude level of the envelope of the full addition signal or the RF signal which is detected is measured, and the record reproduction focus offset is determined which is used when recording or reproduction of the optical disc is carried out, on the basis of the adjustment focus offset with which the measured amplitude level of the envelope of the full addition signal or the RF signal is minimized.

In the optical disc recording and reproduction method according to the aspect of the present invention, the adjustment focus offset for adjusting the height of the objective lens provided to the optical pickup is set, the envelope of the full addition signal or the RF signal obtained from each focused focal point corresponding to the position of the objective lens in the land and the groove formed on the optical disc is detected when the optical disc is rotated in a state where the tracking servo is not performed by using the set adjustment focus offset, the amplitude level of the envelope of the full addition signal or the RF signal which is detected is measured, and the record reproduction focus offset is determined which is used when recording or reproduction of the optical disc is carried out, on the basis of the adjustment focus offset with which the measured amplitude level of the envelope of the full addition signal or the RF signal is minimized.

In the optical disc recording and reproduction method according to the aspect of the present invention, the adjustment focus offset for adjusting the height of the objective lens provided to the optical pickup is set, the envelope of the full addition signal or the RF signal obtained from each focused focal point corresponding to the position of the objective lens in the land and the groove formed on the optical disc is detected when the optical disc is rotated in a state where the tracking servo is performed by using the adjustment set focus offset, the amplitude level of the envelope of the full addition signal or the RF signal which is detected is measured, and the record reproduction focus offset is determined which is used when recording or reproduction of the optical disc is carried out, on the basis of the adjustment focus offset with which the measured amplitude level of the envelope of the full addition signal or the RF signal is minimized.

In the optical disc apparatus according to the aspect of the present invention, it is possible to simply and also preferably adjust the focus offset without using the header read rate.

### BRIEF DESCRIPTION OF THE DRAWINGS

FIG. 1 is a block diagram of a configuration of an optical disc apparatus according to an embodiment of the present invention;

FIG. 2 is an explanatory diagram for describing a difference of light amounts generated by tracks in a land and a groove formed on an optical disc;

FIG. 3 is a flowchart for describing a focus offset adjustment processing in the optical disc apparatus of FIG. 1;

FIGS. 4A and 4B illustrate an envelope of a full addition signal or an RF signal detected in a state where a tracking servo is not performed or in a state where the tracking servo is performed;

FIGS. 5A and 5B illustrate a relation between the focus offset and a reflection amount or a header read rate;

FIG. 6 is a flowchart for describing another focus offset adjustment processing in the optical disc apparatus of FIG. 1; and

FIG. 7 is a flowchart for describing another focus offset adjustment processing in the optical disc apparatus of FIG. 1.

### DESCRIPTION OF THE PREFERRED EMBODIMENTS

Hereinafter, embodiments of the present invention will be described with reference to the drawings.

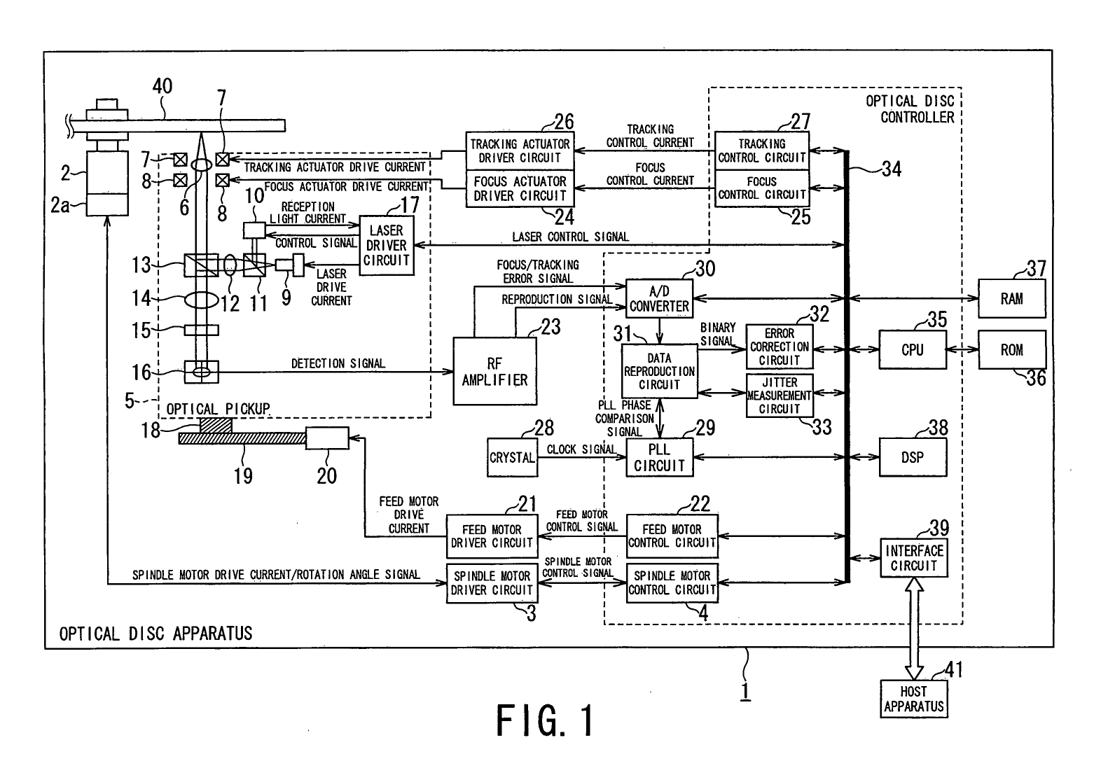

FIG. 1 illustrates a configuration of an optical disc apparatus 1 according to an embodiment of the present invention.

The optical disc apparatus 1 is adapted to perform recording and reproduction of information with respect to an optical disc 40 functioning as information recording medium such as DVD (Digital versatile Disc). The optical disc 40 has grooves formed concentrically or spirally. A concave part of the groove is referred to as land, and a convex part thereof is referred to as groove. A round of the groove or the land is referred to as track. User data is recorded on the optical disc 40 while an intensity-modulated laser beam is emitted along this track (only the groove, or the groove and the land) to form record marks. Data reproduction is performed by detecting a change in reflection light intensity caused by the record marks on the track while a laser beam with a read power which is weaker than the power during the recording is emitted along the track. Deletion of the recorded data is performed through crystallization of a recording layer while a laser beam with an erase power which is stronger than the read power is emitted along the track.

The optical disc 40 is rotated and driven by a spindle motor 2. A rotation angle signal is output from a rotary encoder 2a which is provided to the spindle motor 2, to a spindle motor driver circuit 3. When the spindle motor 2 makes one rotation, the rotation angle signal generates, for example, five pulses. With this configuration, a spindle motor control circuit 4 can determine the rotation angle and the number of rotations of the spindle motor 2 on the basis of the rotation angle signal input from the rotary encoder 2a via the spindle motor driver circuit 3. The spindle motor 2 is controlled by the spindle motor control circuit 4.

Recording or reproduction of information with respect to the optical disc 40 is performed by an optical pickup 5. The optical pickup 5 is linked to a feed motor 20 via a gear 18 and a screw shaft 19, and the feed motor 20 is controlled by a feed motor driver circuit 21. As the feed motor 20 is rotated by way of a feed motor drive current supplied from the feed motor driver circuit 21, the optical pickup 5 is moved in a radius direction of the optical disc 40.

The optical pickup 5 is provided with an objective lens 6 supported by a wire or a plate spring which is not shown in the drawing. The objective lens 6 can be moved in a focusing direction (an optical axis direction of the lens) by way of the drive of a focus actuator 8, and also be moved in a tracking direction (a direction perpendicular to the optical axis direction of the lens) by way of the drive of a tracking actuator 7.

A laser driver circuit 17 supplies a write signal to a laser diode (laser light emitting element) 9 at the time of information recording (during mark formation) on the basis of recording data which is supplied from a host optical disc apparatus 41 via an interface circuit 39. Also, the laser driver circuit 17 supplies a read signal which is smaller than the write signal to the laser diode 9 at the time of information reading.

A front monitor photodiode 10 branches a part of laser light generated by the laser diode 9 at a given ratio by using a half mirror 11, detects the quantity of light, in other words, a reception light signal in proportion to the irradiation power, and supplies the detected reception light signal to the laser driver circuit 17. The laser driver circuit 17 obtains the reception light signal supplied from the front monitor photodiode 10, and controls the laser diode 9 on the basis of the thus obtained reception light signal so that the laser diode 9 emits lights at a laser power (irradiation power) during the reproduction, at a laser power during the recording, and at a laser power during the deletion which are previously set by a CPU 35.

The laser diode 9 emits laser light in accordance with the signal supplied from the laser driver circuit 17. The laser light emitted from the laser diode 9 is emitted onto the optical disc 40 via a collimator lens 12, a half prism 13, and the objective lens 6. The reflection light from the optical disc 40 is guided to an optical detection device 16 via the objective lens 6, the half prism 13, a collective lens 14, and a cylindrical lens 15.

The optical detection device 16 is configured, for example, of four divisional optical detection cells, and adapted to generate a detection signal and output the thus generated detection signal to an RF amplifier 23. The RF amplifier 23 performs a processing on the detection signal supplied from the optical detection device 16. Also, the RF amplifier 23 generates a focus error signal (FE) indicating an error from the just focus, a tracking error signal (TE) indicating an error between the beam spot center of the laser light and the track center, and a reproduction signal (RF) which is a full addition signal of detection signals, and supplies to an A/D converter 30 the focus error signal (FE), the tracking error signal (TE), and the reproduction signal (RF) which have been thus generated.

A focus control circuit 25 generates a focus control signal in accordance with the focus error signal (FE) taken in from the RF amplifier 23 via the A/D converter 30 by a DSP 38 and supplies the thus generated focus control signal to a focus actuator driver circuit 24. The focus actuator driver circuit 24 supplies a focus actuator drive current for driving the focus actuator 8 to the focus actuator 8 in the focusing direction on the basis of the focus control signal supplied from the focus control circuit 25. With this configuration, a focus servo is conducted so that the laser light regularly has the just focus on the recording layer of the optical disc 40.

A tracking control circuit 27 generates a tracking control signal in accordance with the tracking error signal (TE) taken in from the RF amplifier 23 via the A/D converter 30 by the DSP 38 and supplies the thus generated tracking control signal to a tracking actuator driver circuit 26. The tracking actuator driver circuit 26 supplies a tacking actuator drive current for driving the tracking actuator 7 to the tracking actuator 7 in the tracking direction on the basis of the tracking control signal supplied from the tracking control circuit 27. With this configuration, a tracking servo is conducted so that the laser regularly traces the track formed on the optical disc 40.

While such focus servo and tracking servo are conducted, the change in reflection light from the pit or the like formed on the track of the optical disc 40 corresponding to the recorded information reflects the reproduction signal (RF) which is the full addition signal of the detection signals from the optical detection device 16 (the respective optical detection cells). This reproduction signal is supplied to a data reproduction circuit 31 via the A/D converter 30. The data reproduction circuit 31 generates a binary signal of 1 or 0 in accordance with the reproduction signal supplied from the A/D converter 30 and outputs the thus generated binary signal to an error correction circuit 32. Also, at the same time as the binary signal is output to the error correction circuit 32, the data reproduction circuit 31 generates a PLL phase comparison signal which represents a phase difference between a reproduction supplied from a PLL (Phase Locked Loop) circuit 29 and this binary signal, and outputs the thus generated PLL phase comparison signal to the PLL circuit 29.

A jitter measurement circuit 33 measures a jitter of the production signal on the basis of the production signal supplied from the A/D converter 30 and a production clock signal generated in the PLL circuit 29. This measured jitter measurement signal can be read out by the CPU 35 via a bus 34.

The DSP (Digital Signal Processor) 38 performs various computation processings on digital signals such as the focus error signal (FE) and the tracking error signal (TE) which are output from the RF amplifier 23 and then converted into digital signals via the A/D converter 30. The DSP 38 also controls the spindle motor control circuit 4, the feed motor control circuit 22, the focus control circuit 25, and the tracking control circuit 27.

The spindle motor control circuit 4, the feed motor control circuit 22, the focus control circuit 25, and the tracking control circuit 27 are controlled by the DSP 38 via the bus 34.

In addition, the laser driver circuit 17, the PLL circuit 29, the A/D converter 30, the error correction circuit 32, the jitter measurement circuit 33, the DSP 38, and other components are controlled by the CPU (Central Processing unit) 35 via the bus 34. The CPU 35 executes various processings while following an operation command supplied from the host optical disc apparatus 41 via the interface circuit 39 and also following a program stored in a ROM (Read Only Memory) 36 and a program loaded from the ROM 36 onto a RAM (Random Access Memory) 37 to generate various control signals. The CPU 35 supplies the control signals to the respective sections, thus controlling the optical disc apparatus 1 in an overall manner.

Incidentally, in a case of employing only the adjustment method of adjusting the focus offset so that the maximum tracking error signal amplification can be obtained, if the signal at the header section leaks into the tracking error signal, the signal at the header section may be erroneously sampled in some cases. Therefore, it is difficult to perform the focus offset adjustment with a high accuracy. In view of the above, in the past, after this adjustment, the minute adjustment is further performed so that the read rate of the header is maximized. However, in this case, in the stage of the former adjustment, it is necessary to establish a condition that any header read rate can be measured.

Also, according to the above-mentioned technologies proposed in Japanese Unexamined Patent Application Publication Nos. 2000-155961 and 2002-319155 as well, in order to correctly evaluate the reproduction states, it is necessary to establish at least such conditions that “the RF signal exists (the state in which recording has been carried out)” and “the header at the sector of evaluating the reproduction states can satisfactorily perform the reproduction”. Therefore, in the case of using this technology, when the optical disc 40 is an unrecorded disc, it is necessary to perform recording once in order to meet these conditions.

In this manner, according to the related art technologies, it is necessary to read the header in either case, and in order to read the header, the RF signal needs to be binarized as a premise. Thus, it is necessary to adjust a PLL circuit, etc.

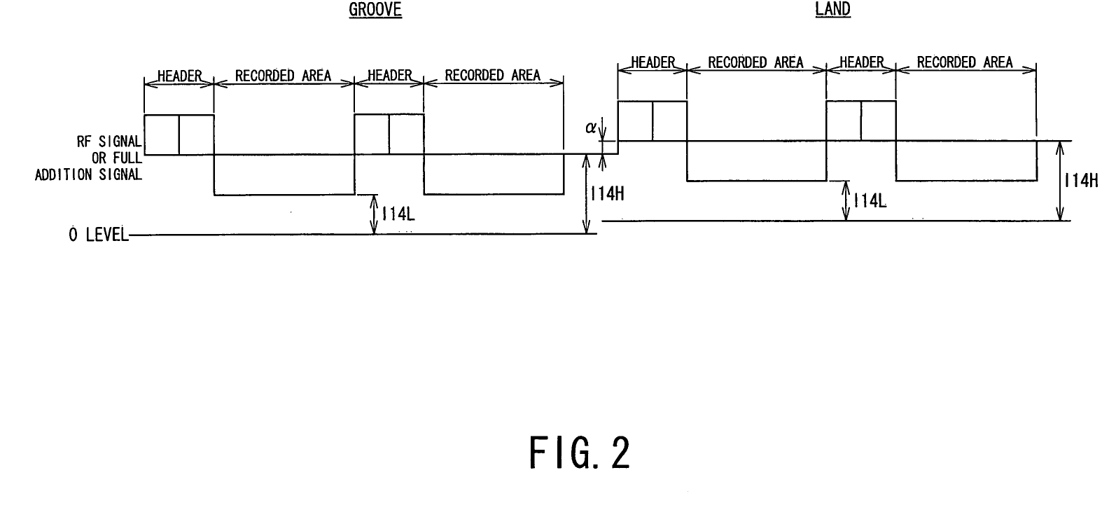

As illustrated in FIG. 2, for example, a peak envelope of the full addition signal or the RF signal equivalent to “I14H” is used to adjust the focus offset. To be more specific, the focus offset for adjusting the height of the objective lens 6 is first set (fixed) in an arbitrary state (an arbitrary value), the focused focal point of the beam spot on the optical disc 40 is uniquely determined. “I14H” in the land or the groove is determined in accordance with the distance from the focused focal point, and thus a slight difference in reflected light amounts from the land and the groove is generated in the focused focal point of the beam spot in the tracks of the land and the groove. That is, in the tracks of the land and the groove, for example, a slight step (□ in FIG. 2) is generated in the full addition signal or the RF signal equivalent to “I14H”. It should be noted that the peak envelope of the full addition signal or the RF signal represents “I14H”, and in a case where the peak envelope of the full addition signal or the RF signal is measured without identifying the land or the groove in a state where the tracking servo is not performed, the beam spot is moved in a radius direction of the optical disc 40. Therefore, when the optical disc 40 is rotated by one turn, in a way like “land □ groove □ land □ . . . ”, while transversing the tracks of the land and the groove, naturally the state is back to the original track channel (the land or the groove) in the end. For that reason, even when the optical disc 40 is rotated by one turn without performing the tracking servo, it is possible to measure “I14H” of the track channel in the land and the groove (that is, the peak envelope amplitude of the full addition signal or the RF signal), and as a result, the difference between the peak envelope amplitudes of the full addition signal or the RF signal in the land and the groove can be measured.

On the other hand, in a case where the peak envelope of the full addition signal or the RF signal is measured by alternately tracing the land or the groove in a state where the tracking servo is performed, it is possible to measure “I14H” including the respective track channels of the land or the groove (that is, the peak envelope amplitude of the full addition signal or the RF signal). In view of the above, for example, by using the peak envelope of the full addition signal or the RF signal equivalent to “I14H”, the adjustment is performed in such a manner that an offset with which the difference in the reflected light amounts from the land and the groove is minimized is set as the focus offset. With this configuration, in a case of adjusting the focus offset, it is possible to perform the focus adjustment only by using an analog signal (analog waveform), and thus the RF signal does not need to be binarized.

Hereinafter, a focus offset adjustment processing using this method will be described.

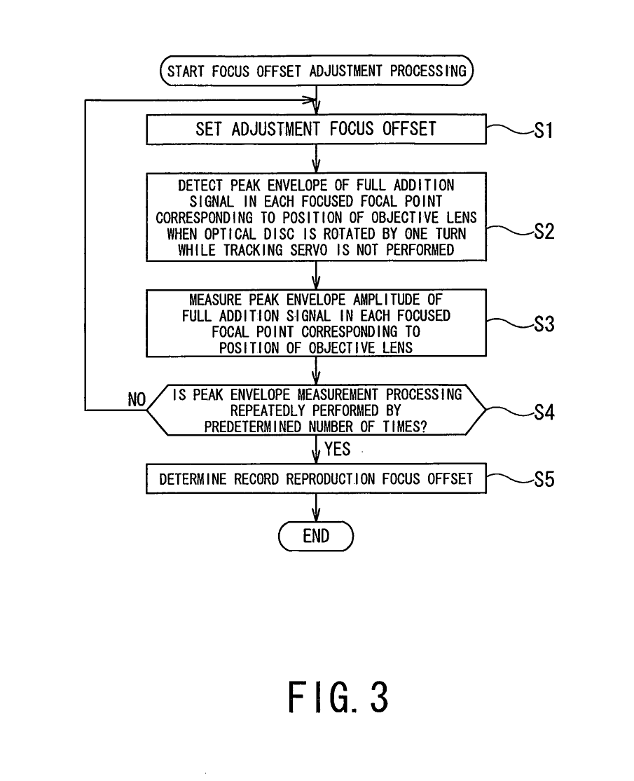

With reference to a flowchart of FIG. 3, a description will be given of the focus offset adjustment processing in the optical disc apparatus 1 of FIG. 1.

In step S1, when the focus offset adjustment processing is performed, the CPU 35 controls the focus control circuit 25 to move the objective lens 6 in a focusing direction (an optical axis direction of the lens) by way of a drive of the focus actuator 8, and the focus offset (the adjustment focus offset) for adjusting the height of the objective lens 6 provided to the optical pickup 5 is first set as an arbitrary value.

In step S2, the CPU 35 controls the optical pickup 5, the spindle motor control circuit 4, the laser driver circuit 17, the RF amplifier 23, and the like, and when the optical disc 40 is rotated at least by one turn in a state where the tracking servo is not performed, the peak envelope of the full addition signal in the focused focal point corresponding to the position of the beam spot position objective lens 6 functioning as the measurement points (for example, about ten beam spot focused focal points corresponding to the position of the objective lens 6) is detected. The RF amplifier 23 supplies the peak envelope of the full addition signal in detected focused focal points 0 to 10 to the A/D converter 30. Of course, the RF signal (reproduction signal) may be used in addition to the full addition signal in the focused focal points 0 to 10 in a focus offset changing interval. It should be noted that as described above, when the optical disc 40 is rotated at least by one turn in a state where the tracking servo is not performed, in a way like “land → groove → land → . . . ”, while transversing the tracks of the land and the groove, naturally the state is back to the original track channel (the land or the groove) in the end.

In addition, as the peak envelope of the full addition signal is detected, it is possible to adjust the focus offset with regard to the optical disc 40 in which an unrecorded area exists, and also even in the recorded area, instead of an average amplitude level of the addition signal, the amplitude level equivalent to the unrecorded case can be used by utilizing “the peak envelope of the addition signal”.

In step S3, the DSP 38 measures the amplitude level of the peak envelope of the full addition signal taken in from the RF amplifier 23 via the A/D converter 30 in accordance with the control of the CPU 35.

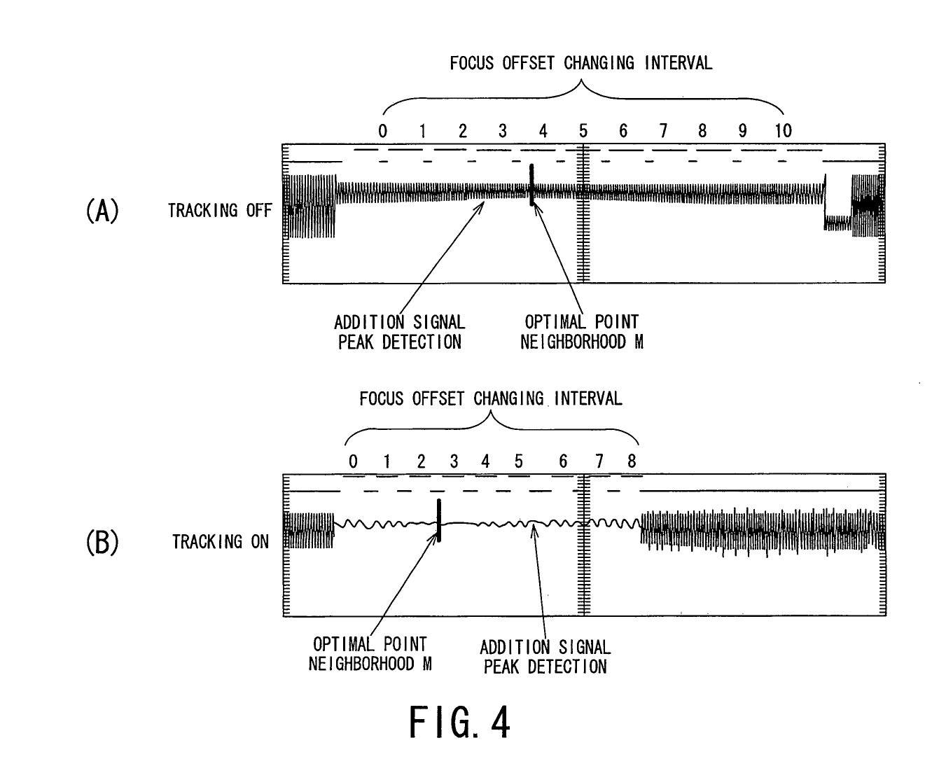

In step S4, the CPU 35 determines whether the peak envelope amplitude measurement processing is repeatedly performed by the predetermined number of times which is previously set (for example, about ten times, etc.). In step S4, in a case where it is determined that the peak envelope amplitude measurement processing is not repeatedly performed by the predetermined number of times which is previously set (for example, about ten times, etc.), the processing is returned to step S1. The processing in step S1 and subsequent steps is repeatedly performed, and the peak envelope amplitude measurement processing of the full addition signal is repeatedly executed. That is, in step S1, a different focus offset (a difficult adjustment focus offset) is arbitrarily set again, and the envelope amplitude measurement processing is performed. With this configuration, for example, as illustrated in FIG. 4A, the peak envelope of the full addition signal in the focused focal points 0 to 10 at the respective measurement points in the focus offset changing interval is detected and measured.

In step S4, in a case where it is determined that the peak envelope amplitude measurement processing is repeatedly performed by the predetermined number of times which is previously set (for example, about ten times, etc.), in step S5, the CPU 35 determines a focus offset (a record reproduction focus offset) used when recording or reproduction of the optical disc 40 is performed, with use of the focus offset (the adjustment focus offset) with which the measured amplitude level of the envelope of the full addition signal or the RF signal is minimized among a plurality of focus offsets (for example, about ten focus offsets) which are respectively set by repeatedly performing the peak envelope amplitude measurement processing by the predetermined number of times (for example, about ten times, etc.). After that, the CPU 35 controls the focus control circuit 25 to move the objective lens 6 in the focusing direction (the optical axis direction of the lens) by way of the drive of the focus actuator 8 to adjust the focus offset used when recording or reproduction of the optical disc 40 is performed on the basis of the determined focus offset used when recording or reproduction of the optical disc 40 is performed. For example, in the case of FIG. 4A, the focus offset in an optimal point neighborhood M with which the amplitude level of the peak envelope of the full addition signal is minimized is set as the focus offset used when recording or reproduction of the optical disc 40 is performed. After that, on the basis of the determined focus offset, the focus offset used when recording or reproduction of the optical disc 40 is performed is adjusted.

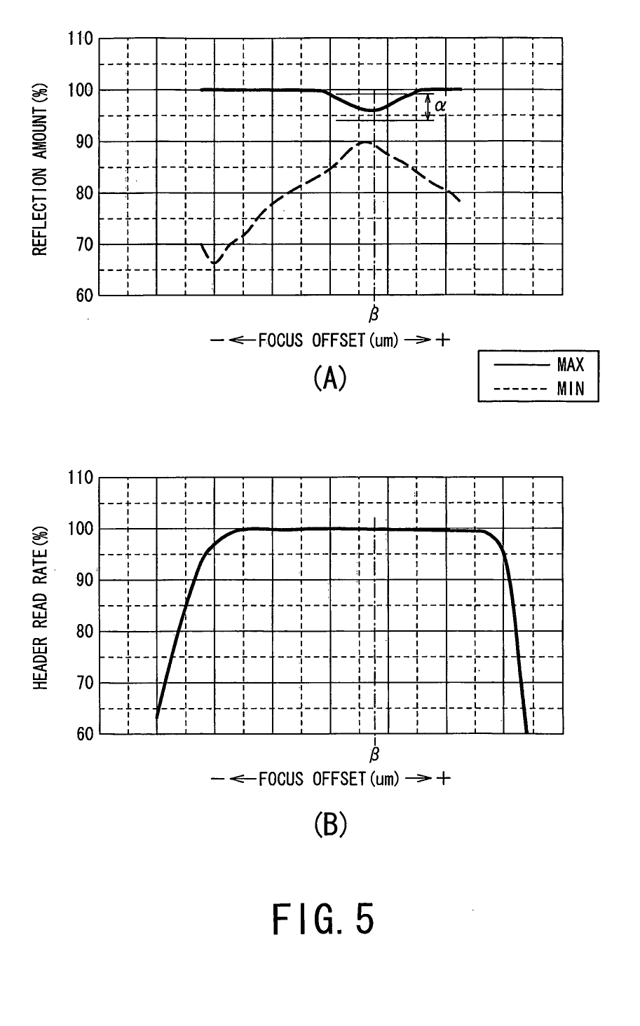

For example, when the focus offset in an optimal point neighborhood M in FIG. 4A is adjusted as the focus offset, as illustrated in FIG. 5A, the focus offset applied to the focus error signal (the offset for changing the height of the objective lens 6 provided to the optical pickup 5) is β (μm). At this time, as illustrated in FIGS. 5A and 5B, the reflection amounts (%) in any tracks of the land and the groove indicate preferable values (in the case of FIGS. 5A and 5B, about a 90% level).

It should be noted that in addition to the above description, after the header is read and the header read rate is measured, in a case where an offset with which the header read rate is optimized is adjusted as the focus offset, if the shape of the spot is changed into a zigzag pattern, the offset corresponding to the optimal header read rate is slightly deviated. In contrast to this, as illustrated in FIG. 5B, when the focus offset applied to the focus error signal is adjusted to β (μm), the header read rate (%) is also naturally close to about 100%. With this configuration, as compared with the case where the header is read, the header read rate is measured, and then the offset with which the header read rate is optimized is adjusted as the focus offset, it is possible to adjust the focus offset with which the header read rate is optimized with certainty.

According to the embodiment of the present invention, the focus offset for adjusting the height of the objective lens 6 provided to the optical pickup 5 is set. When the optical disc 40 is rotated by using the set focus offset in a state where the tracking servo is not performed, the envelope of the full addition signal or the RF signal obtained from each focused focal point corresponding to the objective lens is detected, and the detected amplitude level of the envelope of the full addition signal or the RF signal is measured. Also, by using the focus offset with which the measured amplitude level of the envelope of the full addition signal or the RF signal is minimized, it is possible to determine the focus offset used when recording or reproduction of the optical disc 40 is performed.

With this configuration, without performing the tracking, by only using the analog signal such as the full added signal or the RF signal, after the PLL circuit 29 or the like is adjusted, it is possible to adjust the focus offset while the header is not reproduced. Also, without measuring the reproduction error information (the number of byte errors or the number of header errors), it is possible to adjust the focus offset. Furthermore, it is possible to adjust the focus offsets in the land and the groove formed on the optical disc 40 at the same time. Therefore, without using the header read rate, it is possible to simply and also preferably adjust the focus offset. As a result, the adjustment period of time for the focus offset can be shortened.

It should be noted that in the focus offset adjustment processing described with reference to the flowchart of FIG. 3, after the optical disc 40 is rotated at least by one turn in a state where the tracking servo is not performed, the focus offset is adjusted. However, after the focus offset adjustment processing in which the tracking servo is not performed is executed, in a state where the tracking servo is carried out, the optical disc 40 is rotated by one turned and then the focus offset may be adjusted. Also, only the focus offset adjustment processing in a state where the tracking servo is performed may be carried out. Hereinafter, a focus offset adjustment processing using this method will be described.

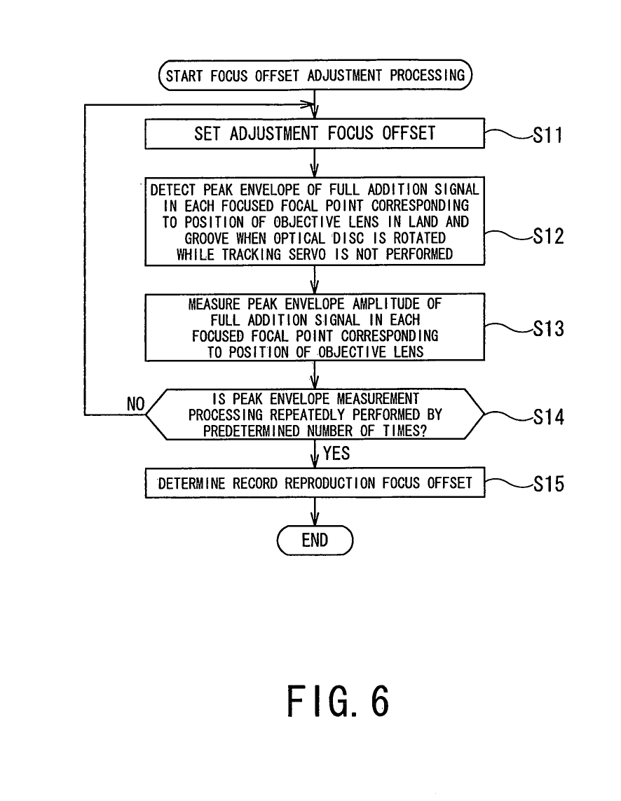

With reference to a flowchart of FIG. 6, a description will be given of the focus offset adjustment processing in the optical disc apparatus 1 of FIG. 1. It should be noted that in this focus offset adjustment processing, after the focus offset adjustment processing in which the tracking servo is not performed is carried out, the focus offset adjustment processing in a state where the tracking servo is performed is carried out as well.

In step S11, when the focus offset adjustment processing is performed, the CPU 35 controls the focus control circuit 25 to move the objective lens 6 in the focusing direction (the optical axis direction of the lens) by way of the drive of the focus actuator 8, and the focus offset for adjusting the height of the objective lens 6 provided to the optical pickup 5 is first set as an arbitrary value.

In step S12, the CPU 35 controls the optical pickup 5, the spindle motor control circuit 4, the laser driver circuit 17, the RF amplifier 23, and the like, and when the optical disc 40 is rotated by one turn in a state where the tracking servo is not performed, the peak envelope of the full addition signal in the focused focal point corresponding to the position of the objective lens 6 functioning as the measurement points (for example, about eight to ten beam spot focused focal points corresponding to the position of the objective lens 6) in the land or the groove formed on the optical disc is detected. The RF amplifier 23 supplies the peak envelope of the full addition signal in detected focused focal points 0 to 8 to the A/D converter 30.

In step S13, the DSP 38 measures the amplitude level of the peak envelope of the full addition signal taken in from the RF amplifier 23 via the A/D converter 30 in accordance with the control of the CPU 35.

In step S14, the CPU 35 determines whether the peak envelope amplitude measurement processing is repeatedly performed by the predetermined number of times which is previously set (for example, about eight to ten times, etc.). In step S14, in a case where it is determined that the peak envelope amplitude measurement processing is not repeatedly performed by the predetermined number of times which is previously set (for example, about eight to ten times, etc.), the processing is returned to step S11. The processing in step S11 and subsequent steps is repeatedly performed, and the peak envelope amplitude measurement processing of the full addition signal is repeatedly executed. With this configuration, for example, as illustrated in FIG. 4B, the peak envelope of the full addition signal in the focused focal points 0 to 8 in the focus offset changing interval is detected.

In step S14, in a case where it is determined that the peak envelope amplitude measurement processing is repeatedly performed by the predetermined number of times which is previously set (for example, about eight to ten times, etc.), in step S15, the CPU 35 determines a focus offset used when recording or reproduction of the optical disc 40 is performed, with use of the focus offset with which the measured amplitude level of the envelope of the full addition signal or the RF signal is minimized among a plurality of focus offsets (for example, about eight to ten focus offsets) which are respectively set by repeatedly performing the peak envelope amplitude measurement processing by the predetermined number of times (for example, about eight to ten times, etc.). The CPU 35 controls the focus control circuit 25 to move the objective lens 6 in the focusing direction (the optical axis direction of the lens) by way of the drive of the focus actuator 8 to adjust the focus offset used when recording or reproduction of the optical disc 40 is performed on the basis of the determined focus offset used when recording or reproduction of the optical disc 40 is performed. For example, in the case of FIG. 4B, the focus offset in the optimal point neighborhood M with which the amplitude level of the peak envelope of the full addition signal is minimized is set as the focus offset used when recording or reproduction of the optical disc 40 is performed. After that, on the basis of the determined focus offset, the focus offset used when recording or reproduction of the optical disc 40 is performed is adjusted.

With this configuration, it is possible to adjust the focus offsets in the land and the groove formed on the optical disc 40 at the same time, and the focus offsets can be simply and also preferably adjusted with a higher accuracy.

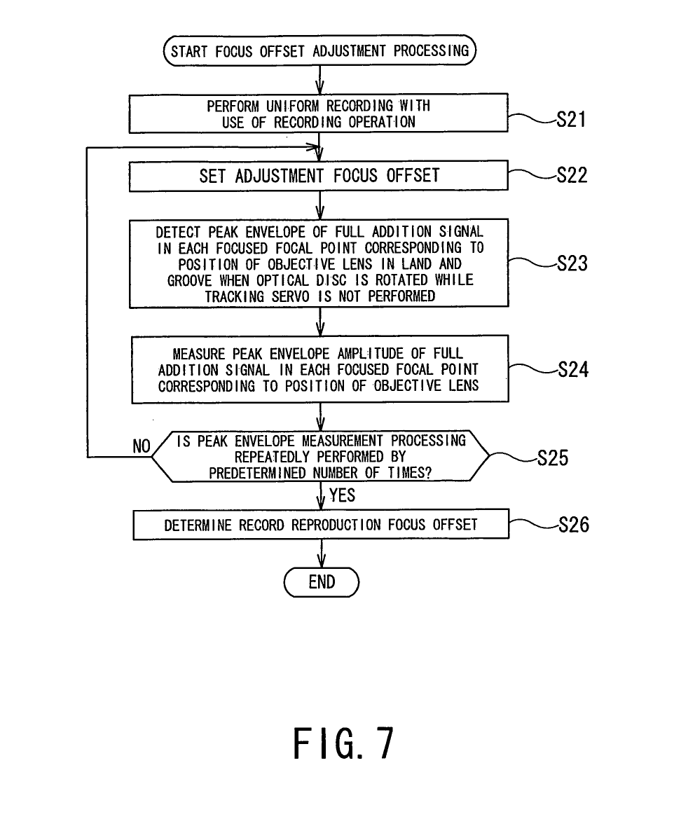

It should be noted that the focus offset adjustment processing may be carried out in combination with a recording power adjustment processing so that an influence from the reflection rate change due to mixture of recorded and unrecorded areas at the time of the adjustment is avoided. That is, as illustrated in the flowchart of FIG. 7, in step S21, before the focus offset adjustment processing in a state where the tracking servo is performed is started, the recording operation by the laser driver circuit 17 and the like is used to form a uniformly recorded area on the optical disc 40, and then the focus offset adjustment processing may be carried out in the tracks of the land and the groove in the uniform recorded area. With this configuration, without using the header read rate, it is possible to simply and also more preferably adjust the focus offset with a higher accuracy.

In addition, the series of the processing described according to the embodiment of the present invention can be executed by using software but also be executed by using hardware.

Furthermore, according to the embodiment of the present invention, such a processing example has been described that the steps of the flowcharts are processed in a time series manner in the stated order, but the present invention also encompasses a processing in which the steps are not necessarily processed in the time series manner and the steps are processed in a parallel manner or individually processed.

1. An optical disc apparatus, comprising:
a setting unit configured to set an adjustment focus offset for adjusting a height of an objective lens provided to an optical pickup;
a detection unit configured to detect an envelope of a full addition signal or an RF signal obtained from each focused focal point corresponding to a position of the objective lens in a land and a groove formed on the optical disc when the optical disc is rotated in a state where a tracking servo is not performed by using the adjustment focus offset which is set by the setting unit;
a measurement unit configured to measure an amplitude level of the envelope of the full addition signal or the RF signal detected by the detection unit; and
a determination unit configured to determine a record reproduction focus offset used when recording or reproduction of the optical disc is carried out, on the basis of the adjustment focus offset with which the amplitude level of the envelope of the full addition signal or the RF signal measured by the measurement unit is minimized.

2. The optical disc apparatus according to claim 1, wherein the measurement unit is configured to repeatedly measure the amplitude level of the envelope of the full addition signal or the RF signal detected by the detection unit by a predetermined number of times which is previously set by using the adjustment focus offsets which are different from each other.

3. The optical disc apparatus according to claim 1, wherein the detection unit is configured to rotate the optical disc by at least one turn in a state where the tracking servo is not performed by using the adjustment focus offset which is set by the setting unit when the envelope of the full addition signal or the RF signal obtained from each focused focal point corresponding to the position of the objective lens in the land and the groove formed on the optical disc is detected.

4. An optical disc apparatus, comprising:
a setting unit configured to set an adjustment focus offset for adjusting a height of an objective lens provided to an optical pickup;
a detection unit configured to detect an envelope of a full addition signal or an RF signal obtained from each focused focal point corresponding to a position of the objective lens in a land and a groove formed on the optical disc when the optical disc is rotated in a state where a tracking servo is performed by using the adjustment focus offset which is set by the setting unit;
a measurement unit configured to measure an amplitude level of the envelope of the full addition signal or the RF signal detected by the detection unit; and
a determination unit configured to determine a record reproduction focus offset used when recording or reproduction of the optical disc is carried out, on the basis of the adjustment focus offset with which the amplitude level of the envelope of the full addition signal or the RF signal measured by the measurement unit is minimized.

5. The optical disc apparatus according to claim 4, wherein the detection unit is configured to detect the envelope of the full addition signal or the RF signal obtained from each focused focal point corresponding to the position of the objective lens in a recorded area formed on the optical disc in which uniform recording is carried out when the optical disc is rotated in a state where the tracking servo is performed.

6. An optical disc recording and reproduction method, comprising:
a setting step of setting an adjustment focus offset for adjusting a height of an objective lens provided to an optical pickup;
a detection step of detecting an envelope of a full addition signal or an RF signal obtained from each focused focal point corresponding to a position of the objective lens in a land and a groove formed on the optical disc when the optical disc is rotated in a state where a tracking servo is not performed by using the adjustment focus offset which is set through a processing in the setting step;
a measurement step of measuring an amplitude level of the envelope of the full addition signal or the RF signal detected through a processing in the detection step; and
a determination step of determining a record reproduction focus offset used when recording or reproduction of the optical disc is carried out, on the basis of the adjustment focus offset with which the amplitude level of the envelope of the full addition signal or the RF signal measured through a processing in the measurement step is minimized.

7. An optical disc recording and reproduction method, comprising:
a setting step of setting an adjustment focus offset for adjusting a height of an objective lens provided to an optical pickup;
a detection step of detecting an envelope of a full addition signal or an RF signal obtained from each focused focal point corresponding to a position of the objective lens in a land and a groove formed on the optical disc when the optical disc is rotated in a state where a tracking servo is performed by using the adjustment focus offset which is set through a processing in the setting step;
a measurement step of measuring an amplitude level of the envelope of the full addition signal or the RF signal detected through a processing in the detection step; and
a determination step of determining a record reproduction focus offset used when recording or reproduction of the optical disc is carried out, on the basis of the adjustment focus offset with which the amplitude level of the envelope of the full addition signal or the RF signal measured through a processing in the measurement step is minimized.
